(19) United States
(12) Patent Application Publication
(10) Pub. No.: US 2021/0354970 A1
(43) Pub. Date: Nov. 18, 2021

(54) APPARATUS AND METHOD FOR TREATING CONTAINERS

(71) Applicant: KHS GmbH, Dortmund (DE)

(72) Inventor: Jürgen Franz Vorwerk, Mörsdorf (DE)

(21) Appl. No.: 17/288,161

(22) PCT Filed: Sep. 24, 2019
(86) PCT No.: PCT/EP2019/075699

§ 371 Date: Apr. 23, 2021

(30) Foreign Application Priority Data
Nov. 8, 2018 (DE) 10 2018 127 962.0

(51) Int. Cl. B67C 7/00; F16J 15/447; B67C 3/22

(52) U.S. Cl. CPC B67C 7/0073; B67C 2003/228; B67C 3/22; F16J 15/447

(57) ABSTRACT

An apparatus for treating containers includes a fixed machine element, a rotating machine element, first and second walls that delimit an interior. The first wall is part of the fixed machine element and the second wall is part of the rotating machine element. A labyrinth seal is formed between the first and second walls, the labyrinth seal has an annular slit that forms a channel. The channel has an inner end that faces the interior and an outer end that faces away from the interior. An underpressure source comprising a blade is at the outer end. Rotation of the underpressure source causes the blade to generate an underpressure in the labyrinth seal. This underpressure generates gas flow from the inner end to the outer end.

### RELATED APPLICATION

This is the national stage of international application PCT/EP2019/075699, filed on Sep. 24, 2019, which claims the benefit of the Nov. 8, 2018 priority date of German application DE102018127962.0.

### FIELD OF INVENTION

The invention relates to filling containers, and in particular, to aseptic filling.

### BACKGROUND

In some filling machines, the containers are filled in an aseptic environment. This typically includes having an aseptic chamber in which filling takes place.

A difficulty with such filling machines is that contaminated air should be kept out of the sterile chamber. In rotating filling machines, it is known to use a rotating seal such that a seal can be maintained between a rotating part of a machine and a stationary part of the machine. Such seals are prone to wear.

It is also known to use a labyrinth seal to discourage air flow between a sterile interior and a non-sterile exterior but without having contact between a rotating and fixed portion of a machine. However, non-sterile air is able to penetrate a labyrinth seal, though at a reduced flow speed.

### SUMMARY

An object of the invention is that of providing an improved apparatus and an improved method for treating containers under aseptic conditions, which in particular optimize the flow of the sterile gas.

Proposed is an apparatus for treating containers, wherein the containers are, in particular, bottles, beakers, cans, and the like. The apparatus comprises a positionally fixed machine element, a rotating machine element, and an interior. The rotating machine element can in this situation be a circulating transport element, which holds and/or transports the containers.

It is further conceivable that the apparatus further comprises two rotating machine elements. In the processing of the containers, these are located predominantly or exclusively in the interior of the apparatus. The interior in this situation is advantageously a sterile interior, such as is required, for example, for the aseptic filling of a liquid filling product into the containers. The interior is delimited by at least one first wall portion and one second wall portion, wherein the first wall portion is assigned to the positionally fixed machine element, and the second wall portion is assigned to the rotating machine element. If further rotating machine elements are present, it is possible for a wall portion delimiting the interior also to be assigned to these elements. The concept of the invention can also be applied to this situation without any problem.

In order to prevent the penetration of generally non-sterile ambient air into the interior, a labyrinth seal is formed between the first and second wall portions, and the pressure in the interior is maintained higher than the air pressure in the surrounding environment, with the result that a slight gas flow prevails from the interior through the labyrinth seal to the outside. The labyrinth seal is a contact-free seal, wherein an annular channel-like slit is formed between the positionally fixed and the rotating machine elements, which in cross-section resembles a labyrinth. The annular channel-like slit comprises an inner channel end facing towards the interior and an outer channel end facing away from the interior. The special sealing effect of the labyrinth seal is based in this situation on the fact that the labyrinth lengthens the flow path from the interior to the outside, as a result of which the flow resistance is also increased. At a given pressure difference between the interior and outside, the gas flow through the labyrinth seal is therefore relatively low.

According to the invention, the apparatus comprises a rotatable underpressure device arranged in the region of the outer channel end, with at least one blade element. At the rotation of the underpressure seal, the at least one blade element generates an underpressure in the labyrinth seal and/or a gas flow directed from the inner channel end to the outer channel end. The flow of the sterile gas from the interior to the outside is therefore supported, and, at the same time, a flow of ambient air into the interior is further suppressed. The flow behavior of the sterile gas is therefore perceptibly improved, such that the pressure difference between the interior and the outside can be kept low, and also less sterile gas flows into the surrounding environment, as a result of which, in turn, less sterile gas must be conveyed back into the interior.

The rotating machine element rotates about a first axis of rotation, and the underpressure device can rotate about a second axis of rotation. Particularly advantageously, the first axis of rotation concurs with the second axis of rotation. The at least one blade element then rotates along the outer channel end, and the underpressure in the labyrinth seal and, respectively, the gas flow directed from the inner channel end to the outer channel end, are simultaneously generated along the circumference of the labyrinth seal.

It is also advantageous if the underpressure device is securely connected to the rotating machine element and/or forms a part of the rotating machine element. Unlike a separately rotating underpressure device, in this situation the number of rotating elements is lower, and there is no requirement for an individual drive for the underpressure device. A rotation of the rotating machine element therefore also incurs a rotation of the underpressure device, with the advantages referred to heretofore.

It can also be of advantage, however, if the underpressure device can be rotated by a motor, and in particular comprises its own drive. The underpressure device can then be operated independently of the rotating machine element. For example, the underpressure device can then also be driven in the event of the rotating machine element being necessarily stopped for a short period for operational reasons and can generate the necessary underpressure in the labyrinth seal and, respectively, the gas flow from the inner channel end to the outer channel end. Moreover, the rotation speed of the underpressure device can be selected independently of the rotation speed of the rotating machine element, and therefore the level of the underpressure in the labyrinth seal and, respectively, of the gas flow from the inner channel end to the outer channel end can be determined.

Advantageously, the at least one blade element is configured as curved and/or rotated or rotatable in relation to a tangential direction to the second axis of rotation. A blade element which is curved in accordance with aerodynamic considerations is in this situation indeed the most elaborate arrangement but generates a more powerful underpressure in relation to a straight blade element of the same size and same speed of rotation. A rotation or pivoting of the blade element in relation to the tangential direction to the second rotation axis can in this situation strengthen the underpressure which is generated. The blade element can then exhibit a constant inclination to the tangential direction, which is particularly easy to achieve in terms of structural design. The blade element can, however, also be rotatable, such that an inclination towards the tangential direction can be adjusted. Due to the change in the inclination, for example, the level of the underpressure and, respectively, the gas flow from the inner channel end to the outer channel end can be influenced. Accordingly, for example, a changed rotation speed or a changed pressure difference between the interior and the outside can be compensated.

It is advantageous if the underpressure device comprises a plurality of rotatable blade elements, which are mounted on bearings individually or in groups. A plurality of blade elements, in particular distributed uniformly, generate a more constant underpressure and a more constant gas flow from the inner channel end to the outer channel end. If these blade elements are mounted so as to be individually rotatable, then the inclination of each blade element to the tangential direction to the second axis of rotation can change individually, in order thereby to obtain specific flow conditions. However, if the blade elements are mounted in groups, then with one adjustment of the inclination several blade elements will be adjusted simultaneously.

It is of advantage if the underpressure device comprises an adjustment device, which adjusts the inclination of the blade element or blade elements to the tangential direction to the second axis of rotation. This adjustment device can be configured in a wide variety of ways, for example as a manual adjustment device, which is actuated by the operating personnel, or an automatic adjustment device which adjusts the inclination of the blade elements as a dependency of specific parameters, for example the rotation speed of the underpressure device or the pressure difference between the interior and the outside.

In one advantageous embodiment variant, one or more cover elements are provided, which at least partially cover the outer channel end. By this covering of the outer channel end, a possible penetration of non-sterile ambient air into the sterile interior is further suppressed. In addition to this, the cover elements contribute to the underpressure generated by the underpressure device coming more specifically into application.

Advantageously, the cover element(s) are connected securely to the underpressure device or represent a part of the underpressure device. Due to the interaction of the cover elements with the underpressure device, particularly good protection against the penetration of non-sterile ambient air into the sterile interior can be ensured in the region of the outer channel end.

In a further advantageous embodiment variant, a further channel is provided, one end of which is located in the region of the outer channel end. The further channel does not have any direct connection with the interior, can be subjected to underpressure, and in particular is covered by the cover element(s). By means of this further channel, a specific air flow can be generated in the region of the outer channel end. This air flow renders it more difficult for other air flows to allow non-sterile air to pass into the interior. The imposition of underpressure can in this situation likewise take place by way of the underpressure device.

It is advantageous if the further channel exhibits one or more openings, by means of which gas can be conveyed. Accordingly, the flow conditions in the further channel can be monitored and controlled still more precisely.

In this situation it is of advantage if the openings are in connection with the ambient air and the gas is air since this represents a particularly simple and economical embodiment variant.

Advantageously, with one improved embodiment form one or more filter elements can be secured to the opening(s), which lead from the outside to the labyrinth seal, and by which the external gas, which is not coming from the interior of the system or the machine, will be suctioned up. The ingress of foreign bodies and/or contaminant substances into the region close to the labyrinth seal will be effectively prevented.

It can also be of advantage, however, if the openings are in connection with a reservoir with purified and/or sterile gas. The risk of a contamination of the interior is then still further reduced. A reservoir with purified gas can be created in this situation, for example, by a closed ring channel, which is connected by a gas line to a compressor and a gas filter.

In another advantageous embodiment variant, provision is made for at least one line leading into the interior, for sterile and/or sterilizing media, and outlets in the interior associated with this line. As a result it is then possible, for example at regular intervals of time or as required, for a sterilization of the interior to be carried out.

A method for treating containers is also proposed. The containers are in this case treated in an apparatus which comprises a positionally fixed machine element, a rotating machine element, and an interior. The interior is delimited by at least one first wall portion and a second wall portion, wherein the first wall portion is assigned to the positionally fixed machine element and the second wall portion is assigned to the rotating machine element. Formed between the first and second wall portions is a labyrinth seal, which comprises an annular channel-like slit, with an inner channel end facing towards the interior and an outer channel end facing away from the interior. With this method the rotating machine element rotates, for example in order to transport containers which are held by the rotating machine element.

According to the invention, the method is put into effect by means of an apparatus according to the foregoing description. In particular, the apparatus comprises a rotatable underpressure device, which with this method is rotated such that an underpressure is generated in the labyrinth seal and/or a gas flow is generated, directed from the inner channel end to the outer channel end. As a result, in particular, the flow behavior of the sterile gas is improved.

Further embodiments, advantages, and possible applications of the invention are also derived from the following description of exemplary embodiments and from the Figures. In this context, all the features described and/or represented in images are in principle the object of the invention, alone or in any desired combination, regardless of their combination in the claims or reference to them. The content of the claims is also made a constituent part of the description.

### BRIEF DESCRIPTION OF THE FIGURES

The invention is explained in greater detail hereinafter on the basis of the Figures relating to exemplary embodiments. The Figures show:

FIG. 1 is a schematic section through a container-treatment machine;

FIG. 2 is a view of an embodiment of a labyrinth seal with an alternative underpressure generating device having a passage;

FIG. 3 is a view of another underpressure generating device;

FIG. 4 shows an underpressure generating device having its own motor;

FIG. 5a is a side view of a blade element's curve; and

FIG. 5b shows an inclination-adjustment device to adjust inclination of a group of blade elements.

Identical reference numbers are used in the figures for elements of the invention which are the same or have the same effect. Moreover, for the sake of easier overview, only reference numbers are represented in the individual figures which are required for the description of the respective figures.

### DETAILED DESCRIPTION

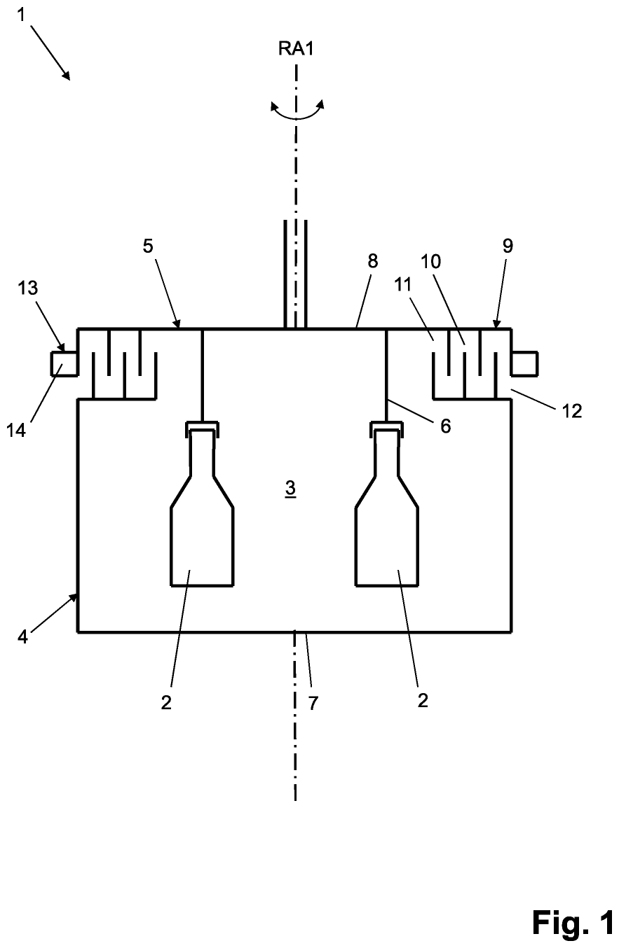

FIG. 1 shows a container-treatment machine 1, examples of which include a rinsing machine, a sterilizer, a filling machine, and aa closing machine. The containers 2 shown in FIG. 1 are bottles. However, other types of containers 2 can be used, such as cans.

During treatment, the containers are in a sterile interior 3. This is useful for cold aseptic filling of heat-sensitive beverages such as, for example, fruit juices.

Only the relevant components of the container-treatment machine 1 are shown. These include a fixed element 4 and a rotating element 5. The rotating element 5 comprises holders 6 that hold the containers 2 during transport thereof by the rotating element 5 about a first axis RA1.

A first wall 7, which is assigned to the positionally fixed machine element 4, and a second wall 8 delimit an interior 3. The first wall 7 is that of the fixed element 5 and the second wall 8 is that of the rotating element 5, delimit the interior 3.

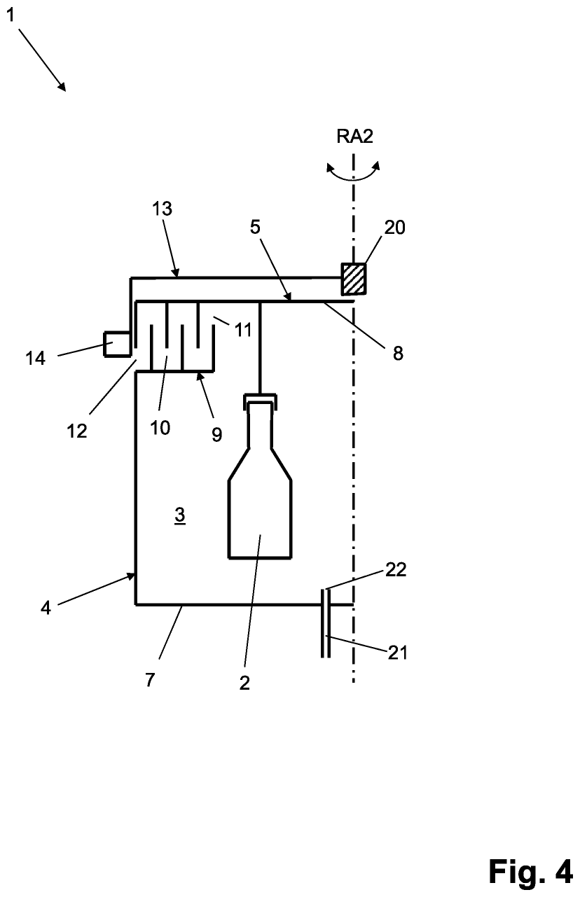

A labyrinth seal 9 between the first and second walls 7, 8 inhibits flow of non-sterile ambient air into the interior 3. To further inhibit such flow, it is useful to maintain the interior 3 at a pressure that is higher than that of the ambient air. This drives sterile air outward through the labyrinth seal 9, thus discouraging flow of air inwards. A gas line, which is omitted for clarity from FIG. 1 but shown in FIG. 4, brings new sterile air to replace this lost sterile air.

An annular slit 10 that forms a channel through the labyrinth seal 9. This creates a tortuous flow path for air and thus increases flow resistance between the interior 3 and the exterior. This increased flow resistance reduces flow of sterile gas outward, thus reducing the required volume of replacement sterile gas. The annular slit 10 extends between an inner end 11, which faces the interior 3, and an outer end 12, which faces away from the interior 3.

The container-treatment machine 1 also includes a rotatable underpressure source 13 arranged in the region of the outer end 12. In the illustrated embodiment, the underpressure source 13 is part of the rotating element 5. The rotatable underpressure source 13 comprises one or more blades 14. As a result of being rotated, the blades 14 generate an underpressure that draws sterile air from interior 3 through the labyrinth seal 9 from the inner end 11 to the outer end 12. This further impedes ingress of non-sterile ambient air into the sterile interior 3.

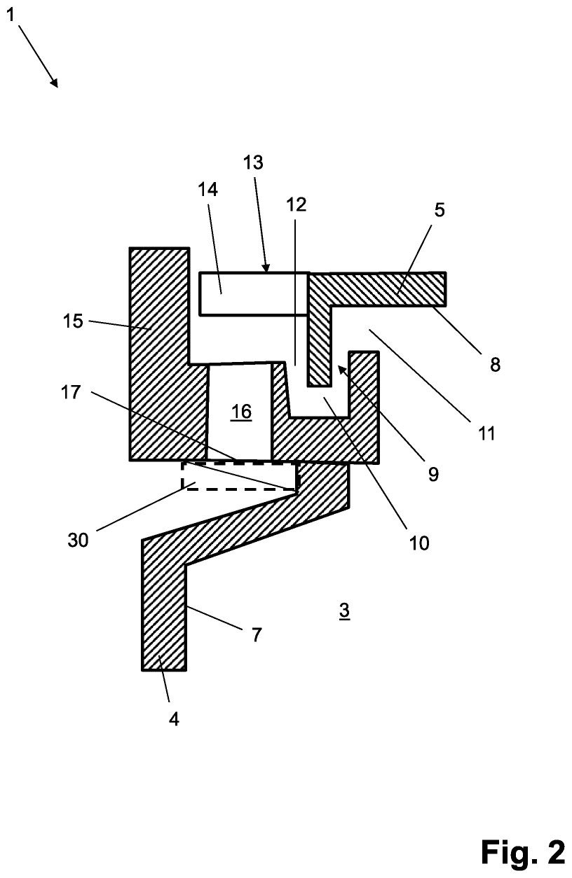

FIG. 2 shows a section through a further container-treatment machine 1 for treating containers 2, in the region of the labyrinth seal 9. The embodiment shown includes a cover 15 that is securely connected to the fixed element 4, and that covers at least sections of the outer end 12. The resulting partial covering of the outer end 12 further impedes a penetration of non-sterile air into the interior 3.

The embodiment shown in FIG. 2 further includes a passage 16 having an upper opening that lies near the outer end 12 and a lower opening 17 into ambient air. The passage 16 is likewise covered by the cover element 15.

Operation of the underpressure source 13, i.e. by rotating the rotating element 5, subjects the passage 16 to an underpressure. This draws ambient air through the lower opening 17 and results in a gas flow through the passage 16. The resulting directed flow also impedes entry of non-sterile air into the interior 3.

Some embodiments include a filter pack 30 at the lower opening 17 to prevent drawing foreign bodies or contaminants substances into the region of the labyrinth seal 9. In an alternative embodiment, the opening 17 connects to a reservoir of sterile gas or air.

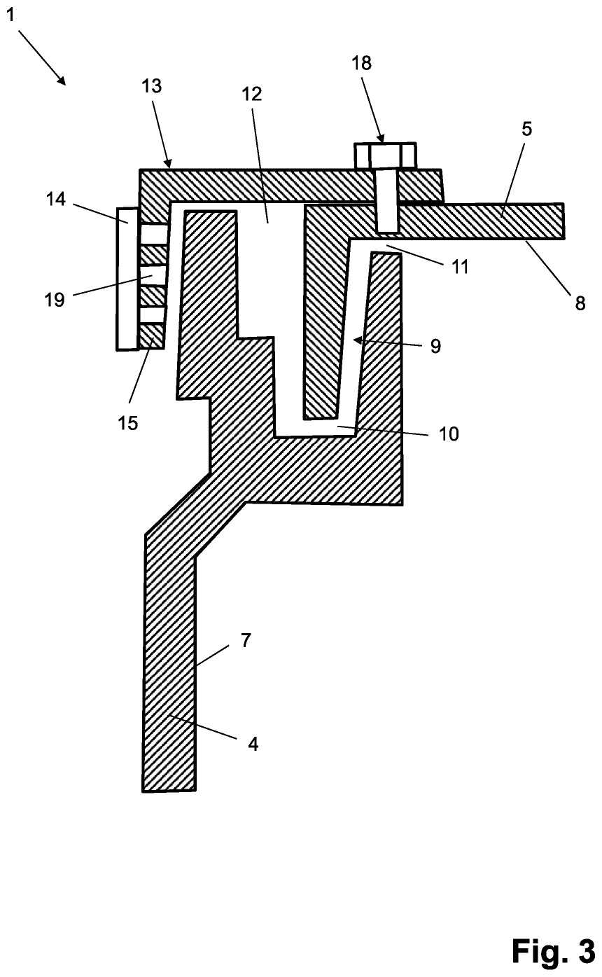

In the embodiment shown in FIG. 3, the cover element 15 forms a part of the underpressure source 13. A screw 18 forms a detachable connection between the underpressure source 13 and the rotating element 5.

The cover 15 comprises slits 19 that are arranged on a side edge near the blade 14. Underpressure generated resulting from rotation of the blades 14 causes a gas flow that is directed outwards through the opening slits 19. This also results in an underpressure at the outer end 12. This embodiment allows for the formation of defined flow conditions in the region of the outer end 12 of the labyrinth seal 9 and therefore provides good protection against the ingress of non-sterile ambient air into the sterile interior 3.

FIG. 4 shows an embodiment in which a separate motor 30 rotates the underpressure source 13 about a second axis RA2. The embodiment shown in FIG. 4 makes it possible for the underpressure source 13 to be rotated independently of the rotating element 5. This permits the blades 14 to rotate more rapidly than the rotating element 5, thus generating a more powerful underpressure in the region of the outer channel end 12. Preferably, the first and second axes RA1, RA2 coincide.

An underpressure source 13 with its own drive 20 is particularly advantageous if the rotating element 5 must be stopped briefly for operational reasons. In this case, the drive 20 can continue to rotate underpressure source 13 and thus maintain the desired gas flow conditions in the region of the outer end 12.

FIG. 4 also shows line 21 having an outlet 22 that opens into the interior 3. The line 21 provides a way to introduce sterilizing medium into the interior 3 at intervals or as required to re-establish or maintain sterile conditions in the interior 3.

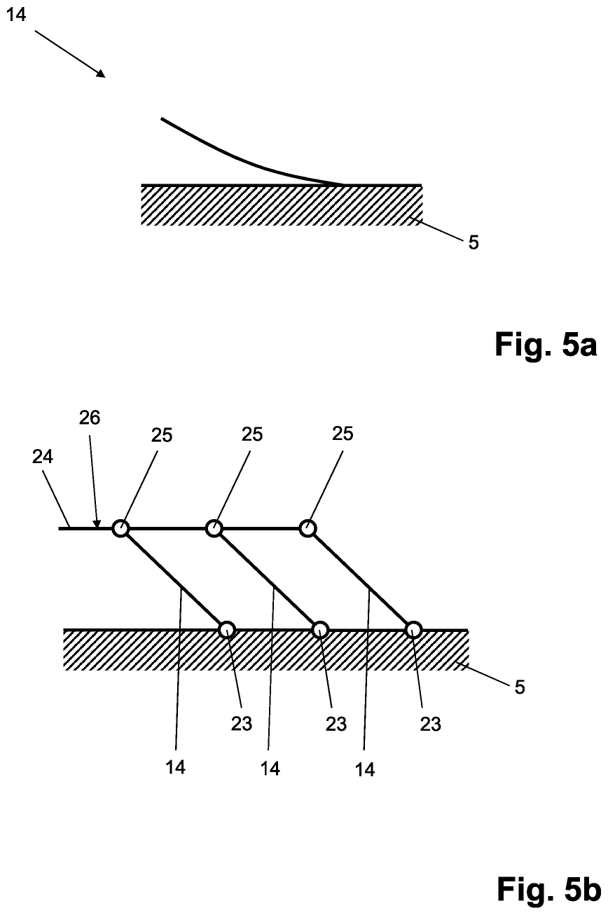

In the view shown in FIG. 5a, it is possible to see a curve in the blade 14. The shape of the curve provides a way to cause an aerodynamic interaction that results in attainment of a desired underpressure at the outer end 12 or attainment of a nearly constant underpressure.

FIG. 5b shows a group of blades 14, each of which has a proximal end and a distal end. The proximal end couples to a bearing 23 to permit rotation relative to the bearing 23. The distal end couples to a link 25. A rod 24 extends to connect all of the links 25. This results in inclination adjuster 26 that adjusts the inclination of the blades 14. The inclination of the blades 14 provides a way to control underpressure in the labyrinth seal 9 or the desired gas flow from the inner end 11 to the outer end 12.

In some embodiments, a motor controls the adjustment device 26, either hydraulically or pneumatically. Some embodiments provide automatic control of the inclination of the blades 14 based on feedback, based on the rotation speed of the underpressure source 13, the pressure difference between the interior 3 and surrounding environment, and/or the degree of contamination of the ambient air.

The invention has been described heretofore on the basis of exemplary embodiments. It is understood that a large number of variants or derivatives are possible, without thereby departing from the scope of protection of the invention defined by the claims.

1-15. (canceled)

16. An apparatus for treating containers, said apparatus comprising a fixed machine element, a rotating machine element, first and second walls that delimit an interior, a labyrinth seal formed between said first and second walls, said labyrinth seal comprising an annular slit that forms a channel, said channel having an inner end that faces said interior and an outer end that faces away from said interior, and an underpressure source at said outer end, said underpressure source comprising a blade, wherein rotation of said underpressure source causes said blade to generate an underpressure in said labyrinth seal, and wherein said underpressure generates gas flow from said inner end to said outer end and wherein said first wall is part of said fixed machine element and said second wall is part of said rotating machine element.

17. The apparatus of claim 16, wherein said rotating machine element rotates about a first axis of rotation, said underpressure source rotates about a second axis of rotation that coincides with said first axis of rotation.

18. The apparatus of claim 16, wherein said underpressure source is securely connected to said rotating machine element.

19. The apparatus of claim 16, further comprising a drive, wherein said drive rotates said underpressure source.

20. The apparatus of claim 16, wherein said blade is curved.

21. The apparatus of claim 16, wherein said blade is one of a plurality of rotatable blades, wherein each of said blades is mounted to rotate relative to a bearing.

22. The apparatus of claim 16, further comprising an inclination adjuster that adjusts an inclination of said blade.

23. The apparatus of claim 16, further comprising a cover that covers at least a portion of said outer end.

24. The apparatus of claim 16, further comprising a cover, wherein said cover is securely connected to said underpressure source.

25. The apparatus of claim 16, further comprising a passage having a first end and a second end, wherein said first end is located at said outer end, and wherein said first end is subjected to said underpressure.

26. The apparatus of claim 16, further comprising a filter and passage through which air is drawn towards said outer end by said underpressure, said air having passed through said filter before reaching said outer end.

27. The apparatus of claim 16, further comprising a passage through which ambient air is drawn towards said outer end by said underpressure.

28. The apparatus of claim 16, further comprising a passage having an opening connected to a reservoir of sterile gas, wherein said underpressure draws sterile gas from said reservoir through said passage and towards said outer end.

29. The apparatus of claim 16, further comprising a line that leads into said interior for delivering sterile gas into said interior.

30. The apparatus of claim 16, wherein said blade moves along a circular path defined by said rotating machine element and said blade is rotatable to form an angle relative to said circular path.

31. A method comprising treating containers with an apparatus that comprises a fixed machine element, a rotating machine element, first and second walls that delimit an interior, a labyrinth seal formed between said first and second walls, said labyrinth seal comprising an annular slit that forms a channel, said channel having an inner end that faces said interior and an outer end that faces away from said interior, and an underpressure source at said outer end, said underpressure source comprising a blade, wherein rotation of said underpressure source causes said blade to generate an underpressure in said labyrinth seal, and wherein said underpressure generates gas flow from said inner end to said outer end and wherein said first wall is part of said fixed machine element and said second wall is part of said rotating machine element, said method comprising causing said underpressure source to draw air from said interior through said labyrinth seal from said inner end to said outer end.
